(19) United States
(12) Patent Application Publication
(10) Pub. No.: US 2006/0227818 A1
(43) Pub. Date: Oct. 12, 2006

(54) Fundamental-frequency monolithic mode-locked laser including multiple gain absorber pairs

(75) Inventors: Alexey Gubenko, St. Petersburg (RU); Alexey Kovsh, Dortmund (DE); Alexey Zhukov, St. Petersburg (RU); Efim Portnoi, St. Petersburg (RU)

Correspondence Address: BROWN & MICHAELS, PC;400 M & T BANK BUILDING, 118 NORTH TIOGA ST, ITHACA, NY, 14850, US

(73) Assignee: NL-Nanosemiconductor GmbH, Dortmund (DE)

(21) Appl. No.: 11/174,794

(22) Filed: Jul. 5, 2005

Related U.S. Application Data
(60) Provisional application No. 60/670,316, filed on Apr. 12, 2005.

(51) Int. Cl. H01S 3/098

(52) U.S. Cl. 372/18

(57) ABSTRACT

A monolithic mode-locked diode laser with improved uniformity of light distribution along the cavity. The laser includes a multiple gain section with more than one gain subsection where the length of each subsection is less than the reciprocal gain coefficient in the gain subsection and a multiple saturable absorber section with more than one saturable absorber subsection where the length of each subsection is less than the reciprocal absorption coefficient in the saturable absorber subsection. The gain subsections alternate with the saturable absorber subsections and are optically coupled in a single waveguide. They are also allocated inside the monolithic cavity such that the total length of the gain subsections and the saturable absorber subsections is equal or close to the total cavity length. The cavity length preferably corresponds to a sufficiently low fundamental repetition frequency. Special measures are preferably provided to ensure mode-locking at the fundamental frequency.

### REFERENCE TO RELATED APPLICATIONS

This application claims an invention which was disclosed in Provisional Application No. 60/670,316, filed Apr. 12, 2005, entitled “FUNDAMENTAL-FREQUENCY MONOLITHIC MODE-LOCKED LASER INCLUDING MULTIPLE GAIN AND ABSORBER PAIRS”. The benefit under 35 USC §119(e) of the U.S. provisional application is hereby claimed, and the aforementioned application is hereby incorporated herein by reference.

### BACKGROUND OF THE INVENTION

1. Field of the Invention

This invention pertains to mode-locked semiconductor lasers, and more specifically, to monolithic passive or hybrid mode-locked semiconductor lasers.

2. Description of Related Art

Mode-locked semiconductor lasers are well suited to a variety of applications which rely on a source of ultrashort optical pulses. Monolithic mode-locked semiconductor lasers have obvious advantages over non-monolithic lasers in terms of, e.g., stability and size. Such lasers are described, for example, in P. A. Morton, et al., “Monolithic hybrid mode-locked 1.3 μm semiconductor lasers,” Appl. Phys. Lett. 56 (1990), pp. 111-113.

Monolithic mode-locked semiconductor lasers have been developed through the use of split-contact Fabry-Perot lasers. In a semiconductor laser having a two-section configuration, it is possible to realize mode-locking by applying a reverse bias to the first section and a forward bias to the second section, thus resulting in operation of the first section as a saturable absorber section and the second section as a gain section. In addition, a radio-frequency modulation signal with the frequency coinciding with the repetition frequency of the optical pulse sequence may be applied to one of these sections or to a separate third section in order to stabilize the mode-locking regime and reduce jitter. Both aforementioned schemes, referred to as passive and hybrid mode-locking, respectively, provide sufficiently short optical pulses.

The repetition rate of optical pulses in a mode-locked laser is determined by the cavity length being equal to N V_{g/}2 L, where V_{g} is the group velocity of light in the laser waveguide, L is the laser cavity length and N is an integer. Repetition rates on the order of ten GHz or even less are required for applications in, for example, optical communication, generation of an optical clock or a sampling signal.

To this end, special measures are to be undertaken in order to avoid harmonic mode-locking (N>1). Even if fundamental mode-locking (N=1) is provided, the cavity length has to be quite long (e.g., L=4-8 mm). In monolithic mode-locked semiconductor lasers with one gain section and one saturable absorber section, these sections must also be quite long. Such long sections promote a non-uniform distribution of light intensity (photon density) along each section. The photon density can reach very high values near the gain-absorber boundary, causing additional gain saturation due to enhanced spatial hole burning (SHB). Gain saturation is an important mechanism responsible for the light pulse broadening and the degradation of pulse power in a mode-locked laser. Moreover, the strong nonuniformity of light intensity distribution results in enhanced amplified spontaneous emissions (ASE), which negatively affects noise characteristics.

In addition to the gain and saturable absorber sections, a monolithic mode-locked laser for generating sufficiently low repetition frequency may include a non-absorptive or low-loss section(s). This section, which is preferably part of the integrated optical waveguide, is nearly transparent to the optical pulse circulating inside the laser cavity. Therefore, it is preferably treated as a “passive” section as opposed to the “active” gain or saturable absorber sections in which the light intensity undergoes amplification or attenuation. The passive section is preferably made sufficiently long in order to ensure the required fundamental frequency. At the same time, the saturable absorber and the gain sections are of appropriate lengths to eliminate the strong nonuniformity of light intensity distribution.

A crucial point is how to create (within an integrated cavity) a semiconductor region which has an absorption edge wavelength shorter than an oscillation wavelength of the gain section. For example, an implementation of a technique known as quantum-well intermixing is described in F. Camacho et al (“Improvements in mode-locked semiconductor diode lasers using monolithically integrated passive waveguides made by quantum-well intermixing”, IEEE Photonics Technology Letters Vol. 9, N. 9, September 1997, pp. 1208-1210). Another example is selective regrowth by wider-bandgap material as discussed in P. B. Hansen et al (“InGaAsP monolithic extended-cavity lasers with integrated saturable absorber for active, passive, and hybrid mode locking at 8.6 GHz,” Appl. Phys. Lett., vol. 62, N. 13, March 1993, pp. 1445-1447) and U.S. Pat. No. 6,031,851. The prior art methods of fabricating the passive section are quite complicated, negatively affecting the yield and also suitable only for limited materials. For example, the regrowth method can not be applied to Al-containing materials, and the application of the quantum-well intermixing to quantum dots is still questionable.

Therefore, in view of the aforesaid disadvantages of the prior art, there is a need in the art for a monolithic mode-locked laser, which can be fabricated using well-developed methods suitable for various materials, with a more uniform distribution of optical modes along the cavity, capable of producing high-power short pulses with low repetition frequency of the order of ten GHz.

### SUMMARY OF THE INVENTION

The invention features a monolithic mode-locked diode laser including an integrated cavity with a length capable of generating a sufficiently low repetition frequency and further including a special means to achieve sufficiently uniform light distribution along the cavity.

More specifically, the means for achieving uniform light distribution includes a multiple gain section with more than one gain subsection where the length of each gain subsection is preferably less than the reciprocal gain coefficient in the gain subsection and a multiple saturable absorber section with more than one saturable absorber subsection in which the length of each saturable absorber subsection is preferably less than the reciprocal absorption coefficient in the saturable absorber subsection. The gain subsections alternate with the saturable absorber subsections and are optically coupled in a single waveguide allocated inside the monolithic cavity.

### BRIEF DESCRIPTION OF THE DRAWINGS

FIG. 1A illustrates the photon density distribution along the cavity of a Fabry-Perot laser.

FIG. 1B illustrates the photon density distribution along the cavity of a two-section mode-locked laser with a gain section and a saturable absorber section.

FIG. 2A illustrates the photon density distribution along an 8-mm-long cavity in mode-locked lasers with one gain subsection and one saturable absorber subsection.

FIG. 2B illustrates the photon density distribution along an 8-mm-long cavity in mode-locked lasers with two gain subsections and two saturable absorber subsections.

FIG. 2C illustrates the photon density distribution along an 8-mm-long cavity in mode-locked lasers with four gain subsections and four saturable absorber subsections.

FIG. 3A shows one configuration for four saturable absorber subsections along the cavity.

FIG. 3B shows another configuration for four saturable absorber subsections along the cavity.

FIG. 3C shows another configuration for four saturable absorber subsections along the cavity.

FIG. 4 shows schematically a mode-locked laser including distributed gain and saturable absorber elements.

FIG. 5 shows spatial distribution of light intensity, carrier concentration and absorption coefficients along the laser cavity.

FIG. 6 is a schematic cross-sectional view illustrating a monolithic mode-locked diode laser including multiple gain and saturable absorber sections in accordance with a preferred embodiment of the invention.

FIG. 7 is a schematic view illustrating an example of a wiring arrangement for passive mode-locking of the diode laser illustrated in FIG. 4.

FIG. 8 shows pulse width (solid symbols) and peak power (open symbols) against average output power for the prior art passively mode-locked lasers (squares) and the lasers of the present invention (circles).

FIG. 9 is a schematic view illustrating an example of the wiring arrangement for hybrid mode-locking of the diode laser illustrated in FIG. 4.

FIG. 10 shows the photon density distribution along the 8-mm-long cavity in mode-locked lasers including four gain, passive, and saturable absorber subsections.

FIG. 11 illustrates a band diagram and optical mode profile in a waveguide of a mode-locked laser including a distributed gain element and a distributed saturable absorber element.

### DETAILED DESCRIPTION OF THE INVENTION

A monolithic mode-locked diode laser includes an integrated cavity with a length capable of generating a sufficiently low repetition frequency and further including a special means to achieve sufficiently uniform light distribution along the cavity.

The laser includes a multiple gain section with more than one gain subsection where the length of each gain subsection is preferably less than the reciprocal gain coefficient in the gain subsection and a multiple saturable absorber section with more than one saturable absorber subsection in which the length of each saturable absorber subsection is preferably less than the reciprocal absorption coefficient in the saturable absorber subsection. The gain subsections alternate with the saturable absorber subsections and are optically coupled in a single waveguide allocated inside the monolithic cavity.

The gain/absorber subsections are relatively short in comparison to the reciprocal gain/absorption coefficient. Consequently, light distribution in each section and in the cavity as a whole is much more uniform compared to that of conventional mode-locked lasers with a single gain and a single absorber section. As a result, the previously mentioned negative effect of SHB and ASE is avoided and the laser of the present invention provides high-power short pulses with low repetition frequency of the order of ten GHz.

Prior art lasers that exploit a low-loss or non-absorptive section must be fabricated by sophisticated techniques. In contrast, the lasers of the present invention may be fabricated by well-developed methods previously approved for a wide variety of material systems, for different types of lasers, and/or for other types of active regions. Therefore, there is broad applicability and improved yield.

A mode-locked laser including several saturable absorber subsections may tend to harmonic mode-locking rather than fundamental mode-locking. In another aspect of the invention, measures are undertaken to avoid harmonic mode-locking. These measures ensure that the following conditions of harmonic mode-locking are NOT jointly satisfied:

1) for all saturable absorber subsections

$${l}_{i} = \frac{K}{N} L$$

where lᵢ is the coordinate of the center of i-th saturable absorber subsection; L is the cavity length; and K and N are integers without a common divisor;

2) N is common for all saturable absorber subsections;

3)

$${τ}_{A} < \frac{1}{{Nf}_{0}}$$

where f₀ is the fundamental frequency, and τ_{A} is the absorber recovery time.

Thus, the laser is mode-locked to the fundamental frequency (the lowest frequency for the given cavity length), and therefore is more suitable for applications in which relatively low frequencies are required.

Light intensity distribution along the cavity is further smoothed in a mode-locked laser including a distributed gain element and a distributed saturable absorber element. This laser represents the ultimate case of the mode-locked laser including multiple gain and saturable absorber sections, in which the number of gain and saturable absorber subsections tends to infinity, with the added advantages of simpler fabrication and wiring.

The distributed gain and saturable absorber elements represent two semiconductor regions which are identical in respect to their spectral characteristics, allocated along the whole length of the laser cavity, and coupled in the laser optical waveguide. The distributed gain element is placed with respect to the conductive paths of electrons and holes in such a manner that carriers of both types are injected in the distributed gain element under appropriate forward bias, producing optical gain. In contrast, the distributed saturable absorber element is placed in such a manner that charge carriers of only one type are preferably injected. Therefore, the distributed saturable absorber element produces absorption rather than gain even if a forward bias is applied to the laser structure.

The absorption, which is provided by the distributed saturable absorber element, is preferably bleachable. The relative coefficient of optical absorption in the distributed saturable absorber element with respect to optical gain in the distributed gain element is adopted, such that the distributed saturable absorber element becomes transparent only for light pulses of sufficiently high intensity, which can only be provided by the superposition of several axial optical modes. Therefore, such a diode laser operates as a passively mode-locked diode laser.

The following discussion will be primarily in terms of GaAs-based ridge-waveguide lasers with a quantum-dot active region. This is for the sake of concreteness only. Those skilled in the art will recognize that the invention can be embodied in devices based on other material systems (e.g., InGaAsP, InAlGaAs/InP, or AlInGaP/GaAs), other types of lasers (e.g., oxide-confined lasers or buried heterostructure lasers), and/or other types of active regions (e.g., quantum well(s) or array(s) of quantum wires).

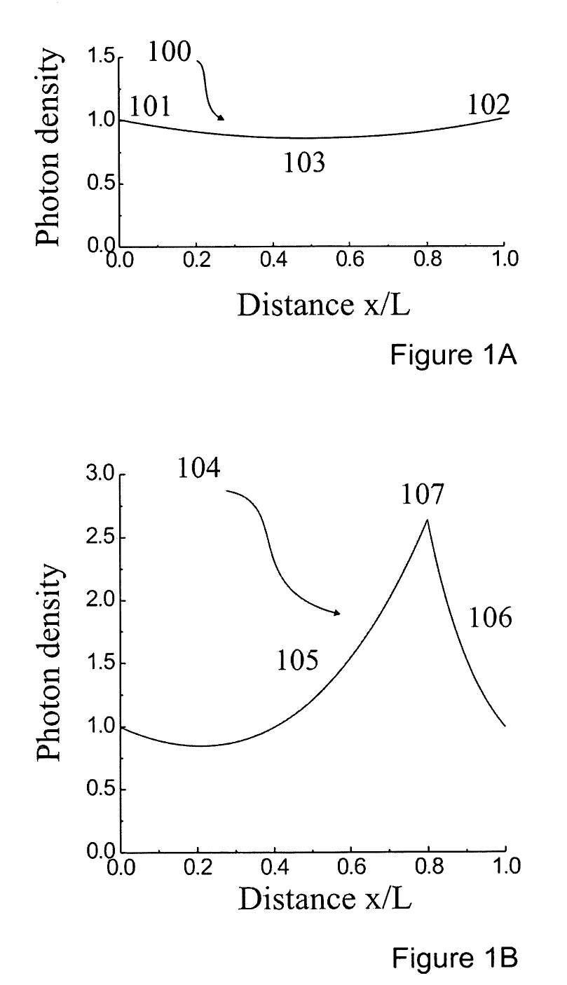

The distribution of light intensity (photon density) along the waveguide of a Fabry-Perot laser is not uniform due to the fact that the light intensity undergoes amplification as the light is traveling inside a semiconductor medium having a positive optical gain coefficient. Another reason for the nonuniformity is a partial light reflection at the cavity mirrors. As a result of these two factors, the distribution of photon density has a bow-like shape (100) as shown in FIG. 1A. If reflections of the left mirror and right mirror are equal, photon density at the left (102) and the right edges (101) of the cavity are also equal, while the minimum photon density (103) occurs at the center. In an ordinary case of two as-cleaved facets, in which the mirror reflection is about 30%, the ratio of the maximum photon density (101) and (102) to the minimum photon density (103) is only 18%. Such a small difference has a negligible effect on the laser's performance.

However, a very different situation takes place in a two-section mode-locked laser (104) in which light amplification in a gain section (105) changes for light absorption in a saturable absorber section (106) at the boundary (107) of these sections, as shown in FIG. 1B. In this case, the photon density distribution becomes highly nonuniform with a characteristic spike at the boundary. The ratio of the maximum to the minimum photon density can be as high as 10 or more depending on the absorption coefficient and section lengths. Such a significant nonuniformity of light distribution along the cavity significantly affects the laser performance.

The photon density near the gain-absorber boundary may reach very high values, resulting in additional gain saturation due to spatial hole burning. Gain saturation is an important mechanism responsible for light pulse broadening in mode-locked lasers. Another related effect is the enhancement of amplified spontaneous emission (ASE) which negatively affects the noise characteristics of a mode-locked diode laser.

A more uniform distribution of the photon density along the cavity of a monolithic mode-locked laser would improve laser performance. This would result in prevention of gain saturation and ASE which, in turn, would lead to better pulse characteristics (i.e. a higher pulse energy for a given pulse width or shorter pulses for a given pulse energy) and a lower noise level.

In the conventional two-section monolithic mode-locked laser, light undergoes amplification continuously along the whole length of the gain section, L_{G}, which is typically quite long compared to the reciprocal gain coefficient (1/G) such that L_{G}>1/G. Similarly, light continuously undergoes absorption along the whole length of the saturable absorber section, L_{A}, which is typically quite long as compared to the reciprocal absorption coefficient, i.e. L_{A}>1/α. These features are the primary reason for considerable nonuniformity of photon density distribution in the prior art monolithic mode-locked laser.

In the monolithic mode-locked laser of the present invention, a single gain section having a length L_{G}>1/G is replaced with a multiple gain section including several gain subsections each having a length L_{G1}, L_{G2} . . . L_{GM}. Similarly, a single saturable absorber section having a length L_{A}>1/α is replaced with a multiple saturable absorber section including several saturable absorber subsections each having a length L_{A1}, L_{A2} . . . L_{AM}. Gain subsections and saturable absorber subsections are allocated inside the monolithic cavity. These subsections alternate and are optically coupled in a single waveguide.

The use of several gain subsections makes it possible to significantly decrease the light path in the laser cavity where light continuously undergoes amplification. The length of each gain subsection is preferably less than the reciprocal of the optical gain coefficient in the gain subsection such that. L_{G1}, L_{G2} . . . L_{GM}<1/G. The same is true for the light absorption. The length of each saturable absorber subsection is preferably less than the reciprocal optical absorption coefficient in the saturable absorber subsection, i.e. L_{A1}, L_{A2} . . . L_{AM}<1/α.

Due to shorter subsections, in which light continuously undergoes amplification and absorption, the characteristic spikes of the photon density at the boundaries of the neighboring gain and saturable absorber subsections become significantly smaller. As a result, photon density distribution in the cavity of the monolithic mode-locked laser of the present invention, as a whole, is much more uniform compared to that of a conventional mode-locked laser. Consequently, the negative effects of SHB and ASE are alleviated.

The number of subsections, M, is chosen such that the total cavity length corresponds to a preselected fundamental repetition frequency of the optical pulses. The total cavity length may be adjusted to be quite long and a repetition frequency of about 10 GHz is easily achieved. Consequently, the monolithic mode-locked laser of the present invention provides ultrashort and high-power pulses with a low repetition frequency of the order of 10 GHz.

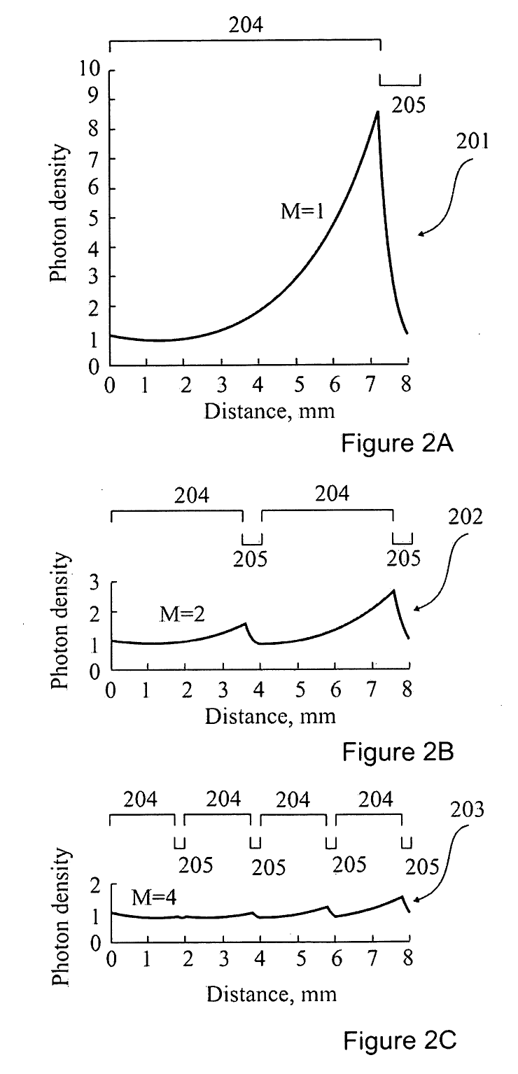

FIGS. 2A through 2C illustrate the photon density distribution along an 8-mm-long cavity in mode-locked lasers with different numbers of gain and saturable absorber subsections. The curve (201) in FIG. 2A corresponds to M=1, which represents a conventional two-section mode-locked laser, the curve (202) in FIG. 2B corresponds to M=2, and the curve (203) in FIG. 2C corresponds to M=4.

In this example, the total lengths of the multiple gain and saturable absorber sections are kept constant at 7.2 and 0.8 mm, respectively. For the given M, each gain subsection (204) has equal length, L_{GM}, such that the total length of the multiple gain section L_{G}=ML_{GM}. Similarly, for a given M, each saturable absorber subsection (205) has equal length. L_{AM}, such that the total length of the multiple saturable absorber section L_{A}=ML_{AM}. This is for simplicity only, because the lengths of the subsections may be varied independently. In the example, the length of the gain subsection (204), L_{GM}, is 7.2, 3.6 and 1.8 mm and the length of the saturable absorber subsection (205), L_{AM}, is 0.8, 0.4 and 0.2 mm for M=1, 2, and 4, respectively.

The absorption coefficient in the saturable absorber subsections, α, is assumed to be 30 cm⁻¹. Under these conditions, the optical gain, G, in the gain subsections that corresponds to the laser threshold is 5 cm⁻¹. Accordingly, the reciprocal optical gain coefficient 1/G is 2 mm and the reciprocal absorption coefficient 1/α is 0.33 mm. Consequently, L_{GM}=1.8 mm<1/G and L_{AM}=0.2 mm<1/α. The M=4 case therefore satisfies the design criteria for a mode-locked laser of the present invention.

FIG. 2A shows that the photon density distribution (201) in the conventional two-section laser is very nonuniform. The ratio of the maximum to the minimum photon densities is about 10. The photon distribution becomes more uniform as the number of subsections increases. In FIG. 2C (M=4), the ratio of the maximum to the minimum photon densities is as low as 1.7. Such a small nonuniformity is comparable with that of a single-section Fabry-Perot laser, as shown by the curve (100) in FIG. 1A.

In the regime of harmonic mode-locking, N>1 pulses simultaneously circulate in the laser cavity, and the optical repetition frequency is an integer multiple of the fundamental cavity round-trip frequency. The minimum optical repetition frequency for the given cavity length is achieved for fundamental mode-locking. Therefore, special measures need to be taken to avoid the harmonic mode-locking of a mode-locked laser which is intended for generation of optical pulses with a relatively low repetition frequency.

Harmonic mode-locking requires very specific locations of saturable absorber subsections along the cavity length. For example, to generate the 4^{th} harmonic in the mode-locked laser having two saturable absorber subsections, both subsections are preferably located at ¼ and ¾ of the cavity length.

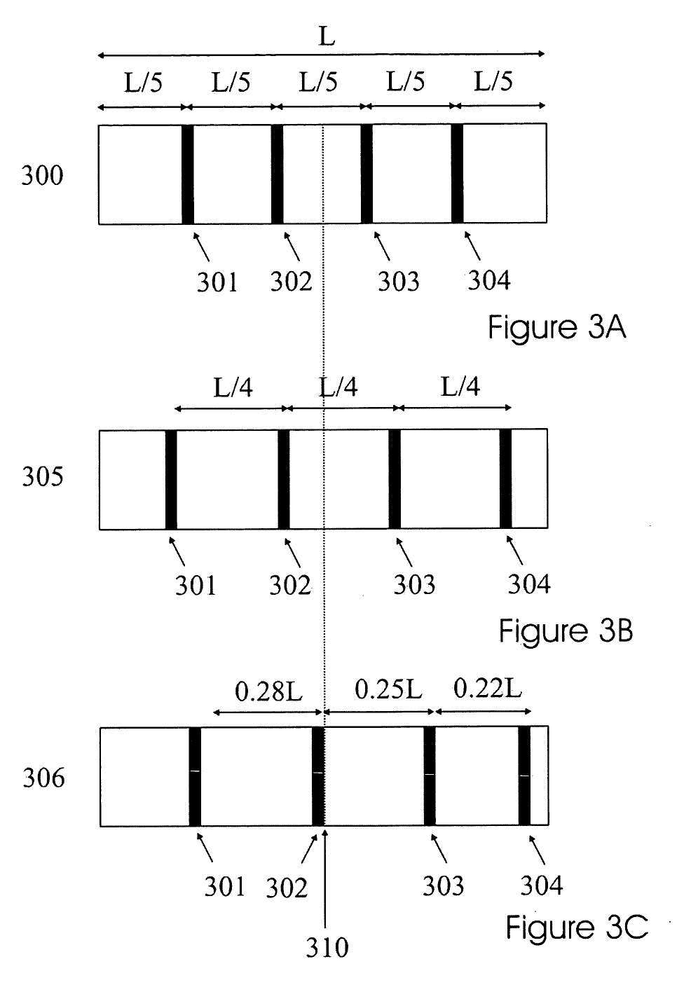

FIGS. 3A through 3C show different designs for four saturable absorber subsections. In cavity (300) of FIG. 3A, the saturable absorber subsections (301), (302), (303), and (304) are located symmetrically with respect to the cavity center (310), such that the distance between two neighboring absorber subsections is approximately one fifth of the cavity length L. This configuration is favorable for generating the 5^{th} harmonic and, therefore, must be avoided in a mode-locked laser intended for fundamental mode-locking.

FIGS. 3B and 3C show two examples of alternative arrangements of the saturable absorber subsections which are incompatible with 5^{th} harmonic mode locking. In cavity (305), the distance between two neighboring absorber subsections is approximately one fourth of the cavity length, L. Fundamental mode-locking is stabilized by asymmetrically locating the saturable absorber subsections (301), (302), (303) and (304) with respect to the cavity center (310). In cavity (306), fundamental mode-locking is ensured by the aperiodic and asymmetric locations of the saturable absorber subsections (301), (302), (303) and (304).

In general, a mode-locked laser including (M-1) saturable absorber subsections may tend to harmonic mode-locking of M-th order if the saturable absorber subsections are located symmetrically with respect to the cavity center, such that the distance between two neighboring absorber subsections is approximately one M-th of the cavity length L. As illustrated in FIG. 3, these requirements are easily avoided for harmonic mode-locking of the lower order (typically M<6) by asymmetric and/or aperiodic arrangement of saturable absorber subsections.

It is known that harmonic mode-locking is only achieved if the saturable absorber is sufficiently fast, i.e. the saturable absorber's recovery time is shorter than the reciprocal repetition frequency, Nf₀, of harmonic mode-locking:

$${τ}_{A} < \frac{1}{{Nf}_{0}} ,$$

where f₀ is the fundamental frequency. Therefore, higher-order harmonic mode-locking is unlikely to occur because repetition frequency becomes too high.

To summarize the above considerations, the mode-locked laser of the present invention includes special measures to avoid harmonic mode-locking. These measures ensure that the following conditions are NOT simultaneously satisfied:

1) for all saturable absorber subsections

$${l}_{i} = \frac{K}{N} L$$

where lᵢ is the coordinate of the center of i-th saturable absorber subsection; L is the cavity length; and K and N are integers without a common divisor;

2) N is common for all saturable absorber subsections;

3)

$${τ}_{A} < \frac{1}{{Nf}_{0}}$$

where f₀ is the fundamental frequency, and τ_{A} is the absorber recovery time.

Thus, the laser is mode-locked to the fundamental frequency, i.e. the lowest frequency for a given cavity length, and therefore is more suitable for applications in which relatively low frequencies are required.

The data presented in FIG. 2 demonstrate that the light intensity distribution along the cavity becomes more and more uniform as the number of subsections increases. However, a larger number of short subsections may lead to problems in wiring and fabrication. Providing a distributed gain element and a distributed saturable absorber element in which all the gain subsections and, respectively, all the saturable absorber subsections are inherently connected, for example, inside the epitaxial structure significantly simplifies the structure. Thus, a mode-locked laser including distributed gain and saturable absorber sections represents the ultimate case of the mode-locked laser including multiple gain and saturable absorber sections, in which the number of gain and saturable absorber subsections tends to infinity, with the added advantage of simpler fabrication and wiring.

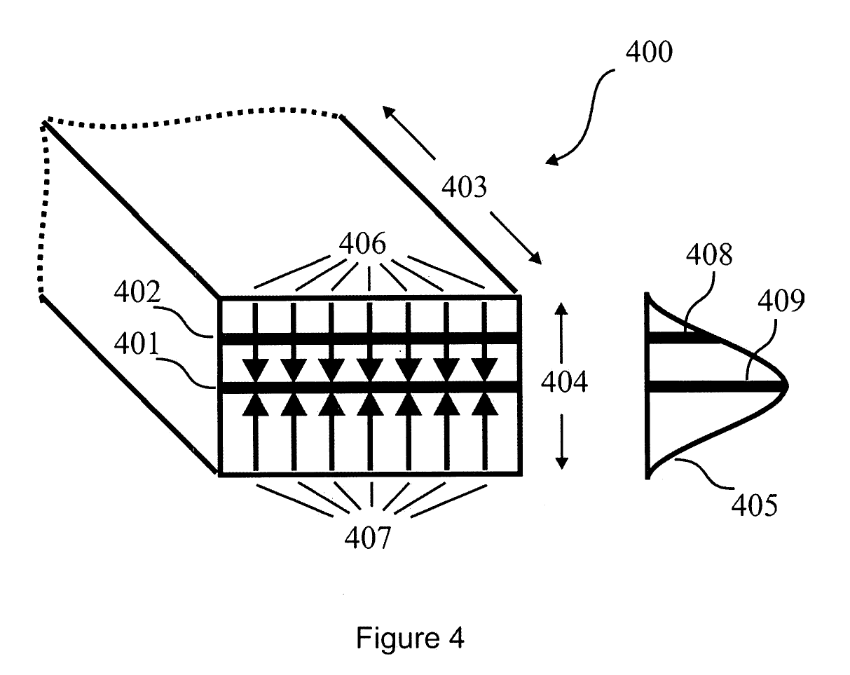

A cross-sectional view of a monolithic mode-locked laser (400) including a distributed gain element (401) and a distributed saturable absorber element (402) is schematically shown in FIG. 4.

The distributed gain element (401) and the distributed saturable absorber element (402) represent two semiconductor regions which are identical in respect to their spectral characteristics (for example, two quantum wells of the same chemical composition and width, or two planes of self-organized quantum dots deposited under similar conditions). The distributed gain element (401) and the distributed saturable absorber element (402) are allocated along the whole length of the laser cavity (403) and are coupled in the laser optical waveguide (404), such that each element has a certain overlap with the optical mode (405).

The distributed gain element (401) is placed with respect to the conductive paths of electrons (406) and holes (407), in such a manner that both electrons (405) and holes (406) can be injected in the distributed gain element (401), thus producing optical gain when the appropriate forward bias is applied to the laser structure (400).

The distributed saturable absorber element (402) is placed with respect to the conductive paths (406) and (407) in such a manner that charge carriers of only one type, for example electrons (406), are preferably injected in the distributed saturable absorber element (402). Therefore, the distributed saturable absorber element (402) produces absorption rather than gain even if a forward bias is applied to the laser structure (400).

Because the distributed gain element (401) and the distributed saturable absorber element (402) are optically coupled by means of the laser optical waveguide (404), the optical radiation (which can be generated by the distributed gain element (401)) is absorbed by the distributed saturable absorber element (402). Each time an event of photon absorption takes place in the distributed saturable absorber element (402), an electron-hole pair is generated, resulting in a reduction in the absorption probability for the next events of photon absorption.

Therefore, the absorption, which is provided by the distributed saturable absorber element (402), is preferably bleachable. Hence, the distributed saturable absorber element (402) is transparent for the light radiation generated by the distributed gain element (401) if the optical mode (405) is of sufficient intensity.

The relative coefficient of optical absorption in the distributed saturable absorber element (402), with respect to optical gain in the distributed gain element (401), is controlled by the relative intensities (408) and (409) of the optical mode (405) at the distributed saturable absorber element (402) and at the distributed gain element (401). The relative intensities (408) or (409) of the optical mode (405) can then be chosen at will by appropriate positions of the distributed saturable absorber element (402) and of the distributed saturable absorber element (401) with respect to the laser optical waveguide (404).

The relative coefficient of optical absorption in the distributed saturable absorber element (402), with respect to optical gain in the distributed gain element (401), are optionally controlled by the appropriate number of identical quantum wells or quantum dot planes in the distributed saturable absorber element (402) with respect to the number of identical quantum wells (quantum dot planes) in the distributed gain element (401).

The relative coefficient of optical absorption in the distributed saturable absorber element (402), with respect to optical gain in the distributed gain element (401), is preferably adopted such that the distributed saturable absorber element (402) remains opaque for the low-intensity light pulses. At the same time, it becomes transparent for the high-intensity light pulses. This level of light intensity is achieved when several axial modes travel together (in-phase) along the laser cavity (403). At the same time, a single axial mode has intensity insufficient for bleaching the distributed saturable absorber element (402).

Therefore, the diode laser (400) including the distributed saturable absorber element (402) and the distributed gain element (401) is preferably designed such that only synchronized axial modes can freely travel inside the laser cavity (403) producing a periodic sequence of short optical pulses. Therefore, the diode laser operates as a passively mode-locked diode laser.

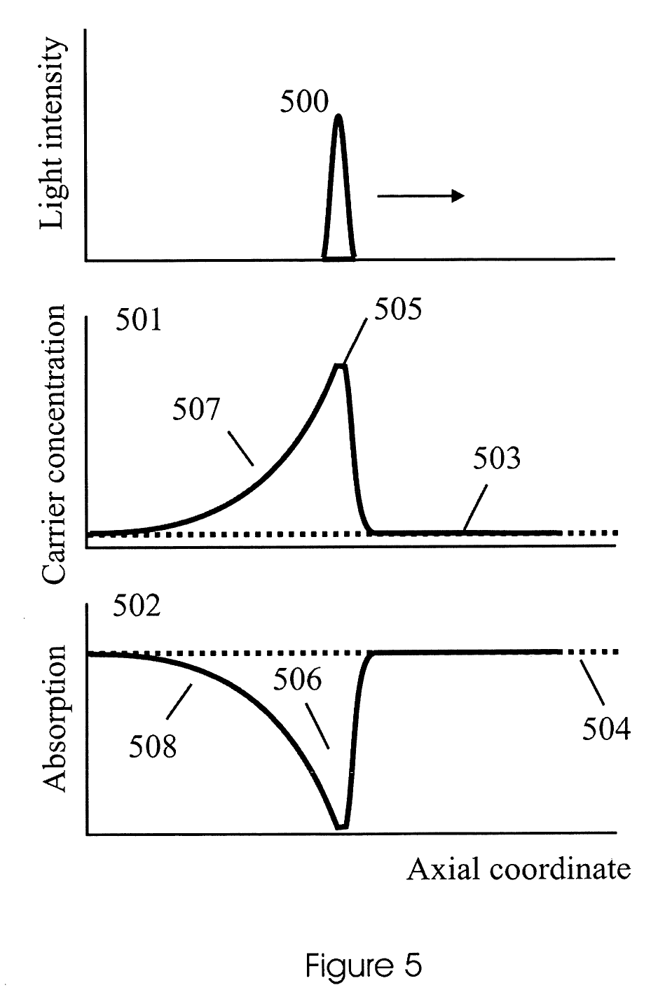

A high-intensity optical pulse (500) traveling along the laser cavity (403) of the mode-locked laser (400) produces a spatial variation of the carrier concentration (501) in the distributed saturable absorber element (402), as shown in FIG. 5. The variation of the carrier concentration (501) results in a corresponding spatial variation of the absorption coefficient (502) in the distributed saturable absorber element (402). The direction of pulse propagation is shown by the horizontal arrow.

Ahead of the optical pulse (500), the carrier concentration (501) is at its minimum (503) because charge carriers of only one type are preferably injected by electrical pumping. Consequently, the absorption coefficient (502) is close to its maximum value (504), which is characteristic of an unpumped material.

The optical pulse (500) maintains a high concentration (505) of non-equilibrium charge carriers of both types. Therefore, the distributed saturable absorber (402) is bleached and the absorption coefficient (502) is close to its minimum value (506), which is characteristic of a material with a high concentration of non-equilibrium charge carriers.

After the optical pulse (500), the carrier concentration (501) gradually changes from its maximum level (505) back to its minimum level (503) within the transient region (507). Accordingly, the absorption coefficient (502) gradually changes from its minimum value (506) back to its maximum value (504) within the transient region (508). The width of the transient regions (507) and (508) depends on the rates of carrier recombination and carrier diffusion along the axial coordinate. Fast diffusion and slow recombination result in broadening the transient regions (507) and (508), whereas slow diffusion and fast recombination result in shortening the transient regions (507) and (508).

For stable mode locking, the distributed saturable absorber element (402) has to be completely recovered by the time the optical pulse reaches the same point after its round trip inside the laser cavity. This means that the transient regions (507) and (508) must be sufficiently narrow. In this respect, quantum dot arrays have certain advantages over quantum wells because of the suppression of the carrier diffusion along the distributed saturable absorber element (402).

The mode-locked laser of the present invention is intended for generation of a pulse sequence with a relatively low repetition frequency (a few GHz); consequently, the time delay between two consecutive pulses is of the order of 0.1 nanoseconds (ns) or even longer. Such a long delay is sufficient for complete recovery of the distributed saturable absorber element by means of carrier recombination. Radiative recombination in the distributed saturable absorber element may be supplemented by non-radiative recombination which may be quite fast due to, for example, low-temperature material growth.

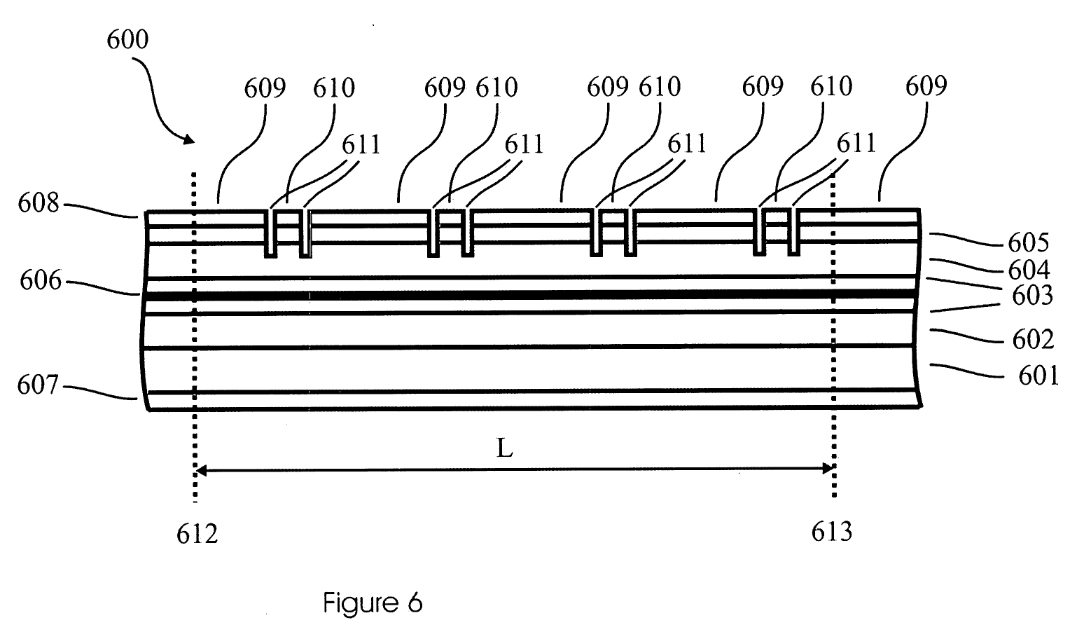

As shown in FIG. 6, a monolithic mode-locked diode laser (600) of the present invention is constructed as a Fabry-Perot diode laser including multiple gain and saturable absorber sections.

On a n+ doped substrate (601), a layered structure is epitaxially grown including, in order, a n-doped first cladding layer (602), a waveguiding layer (603), a p-doped second cladding layer (604), and a p+ contact layer (605). In one example, the layers are a n+ doped GaAs substrate (601), a n-AlGaAs first cladding layer (602), a GaAs waveguiding (603) layer, a p-AlGaAs second cladding layer (604), and a p+ GaAs contact layer (605). The waveguiding layer (603) also plays the role of a matrix where a laser active layer (606) is embedded. The laser active layer (606) is formed by the successive deposition of several planes of quantum dots separated by spacer layers, which are made of GaAs in the example. Each quantum dot plane preferably represents a plane of Stranski-Krastanow self-organized quantum dots embodied in an InGaAs material system in the example. Each plane is deposited under the same growth conditions. Alternatively, the waveguiding layer (603) and the spacer layers may be made of AlGaAs having an Al mole fraction smaller than that in the cladding layers (602) and (604). Also, InAlAs or InAlGaAs materials may be used for the quantum dots.

The second cladding layer (604) and the contact layer (605) are preferably processed into a longitudinal ridge structure with side walls protected by a dielectric film. The ridge structure has a width of about 3-10 μm and serves to localize the light generation within a single spatial mode.

An n-ohmic contact (607) is preferably formed on the back side of the substrate (601). A p-ohmic contact (608), formed on top of the contact layer (605), is split into a series of alternating subsection pairs including a longer subsection (609) and a shorter subsection (610). The neighboring subsections are electrically isolated from each other by isolating mesas (611) etched through the contact layer (605) and the top part of the second cladding layer (604). The total length of the subsection pair (609) and (610) is preferably about 0.15-0.25 μm in which the shorter subsection (610) preferably occupies from 5 to 20% of the total length.

The ohmic contacts (607) and (608) are fabricated by methods well-known by those skilled in the art. Metals are selected in accordance with the semiconductor material of the substrate (601) and the contact layer (605). AuGe/Au (or AuGe/Ni/Au) and AuZn/Au (or Ti/Pt/Au, or Cr/Au) are preferably used in a GaAs-based laser structure for the n- and p-ohmic contacts, respectively.

The optical resonator is defined by cleaved facets (612) and (613), which are optionally coated with high reflective or low reflective dielectric structures. The facet cleavage is performed such that the shorter subsections (610) are located asymmetrically with respect to the cavity center in order to ensure fundamental rather than harmonic mode-locking. The cavity length, L, is preferably about 4-8 mm, thereby providing a fundamental repetition frequency of about 5-10 GHz. The laser cavity preferably includes four or five shorter subsections (610); three or four inner longer subsections (609) and two outer subsections (609) of reduced length.

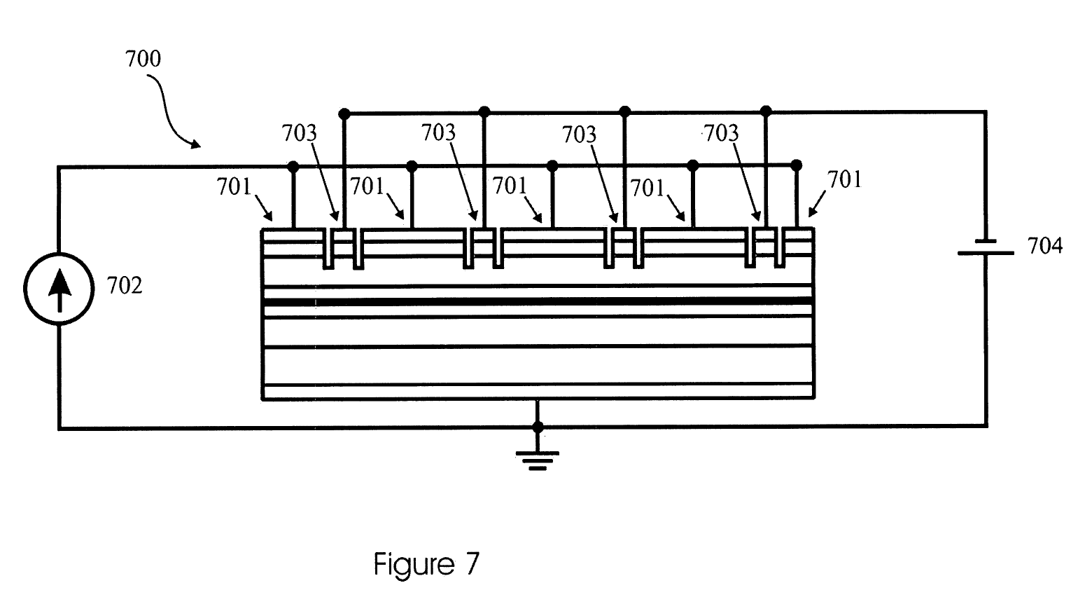

In one embodiment, the monolithic mode-locked diode laser (600) shown in FIG. 6 is driven as a passive mode-locked laser (700), as illustrated in FIG. 7.

Subsections (701), which correspond to the longer subsections (609) of FIG. 6, are electrically connected in parallel. During normal use, a suitable forward current is provided by a DC source (702) to be applied to the subsections (701) to cause laser light generation. Subsections (703), which correspond to the shorter subsections (610) of FIG. 6, are electrically connected in parallel. During normal use, a suitable negative bias is provided by a DC source (704), which is to be applied to the subsections (703) to cause absorption of low intensity pulses and propagation of high intensity pulses.

Thus, the subsections (701) act as gain subsections and the plurality of gain subsections (701) operate as a multiple gain section of the mode-locked laser diode (700). The subsections (703) act as saturable absorber subsections and the plurality of saturable absorber subsections (703) operate as a multiple saturable absorber section of the mode-locked laser diode (700). The mode-locked laser (700), as a whole, operates as a passively mode-locked laser.

Due to the multiple gain and saturable absorber sections, the light distribution along the cavity of the mode-locked laser is essentially uniform, as illustrated by the curve (203) in FIG. 2. Under appropriate driving conditions, self-starting and stable CW mode-locking at the fundamental repetition frequency is achieved. This results in a sequence of high-power short pulses with a low repetition frequency of the order of 10 GHz. The output light beam is preferably coupled to an optical fiber or other optical circuits by coupling optical elements (not shown in FIG. 7). The laser output is useful for optical data processing, optical communication, and the generation of an optical clock or a sampling signal.

### EXAMPLES

A series of mode-locked lasers were grown by molecular-beam epitaxy and fabricated in accordance with the design of FIGS. 6 and 7. Each quantum dot plane in the laser active region was formed by low-temperature deposition of 2.5 monolayers of InAs capped with a 5-nm-thick In_{0.15}Ga_{0.85}As layer. The spacer thickness was 33 nm. The wavelength of emission was about 1280 nm. The ridge width was 6 μm. The 8-mm-long cavity included four 0.2-mm-long saturable absorber subsections, three 1.8-mm-long inner gain subsections, and two outer gain subsections ranging from 0.3 to 1.5 mm. Thus, the total length of the multiple gain section was 7.2 mm and the total length of the multiple saturable absorber section was 0.8 mm.

For the sake of comparison, part of the epitaxial wafer was processed into two-sectional mode-locked lasers of the same edge width and cavity length. In contrast to the design illustrated in FIGS. 6 and 7, this type of mode-locked laser includes a single gain section having a length of 7.2 mm and a single saturable absorber section having a length of 0.8 mm.

The fabricated chips were mounted on copper heatsinks and tested at 30° C. under variable CW bias applied to either the single gain section in the conventional two-section mode-locked laser or to the multiple gain section in the invented mode-locked laser. The saturable absorber (single or multiple section) was negatively biased at −5V. The power and dynamic characteristics of mode-locked lasers of both types were compared. The light pulse repetition frequency and the pulse duration were controlled by the second-order autocorrelation technique. Under such driving conditions, lasers of both types operated at the fundamental repetition frequency of about 5 GHz, as defined by the cavity length.

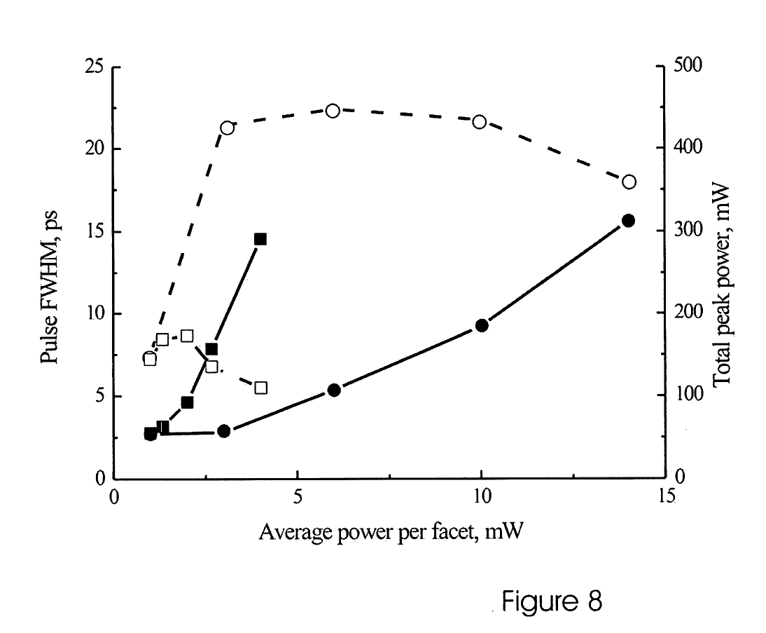

The average output power increases as the DC forward current flowing through the gain section increases. FIG. 8 shows pulse width (solid symbols) and peak power (open symbols) for the prior art passively mode-locked lasers (squares) with single saturable absorber section and single gain section and for the lasers of the present invention (circles) with a multiple saturable absorber section and a multiple gain section. The pulse width (full width at half maximum) and the peak power (both facets) are plotted against the average output power.

The pulse width increases with the average power for the lasers of both types. However, FIG. 8 shows that pulse broadening is less pronounced in the laser of the present invention. For example, pulses as short as 2.8 picoseconds (ps) were measured at the average power of 3 mW in the laser of the present invention (which corresponds to a peak power of more than 400 mW). In contrast, the prior art laser demonstrates a similar pulse width at only ˜1 mW of the average power (which corresponds to the peak power of not more than 150 mW). In the laser of the present invention, a maximum peak power of 448 mW is achieved at an average power of 6 mW with the pulse width of 5.36 ps. In contrast, the maximum peak power of the conventional laser is only 173 mW with a pulse width of 4.6 ps.

Thus, the laser of the present invention demonstrates much higher peak power for the same pulse width or shorter pulses with the same peak power as compared to the conventional mode-locked laser having a single gain section and a single saturable absorber section. Such an improvement is attributed to the more uniform light distribution in the invented mode-locked laser owing to the multiple nature of the gain and the absorber sections.

Further improvement of the mode-locked pulse power characteristics in the laser of the present invention has been achieved by biasing the multiple saturable absorber section to a higher negative voltage of −6V. Also, the laser facets were high-reflective/anti-reflective (HR/AR) coated. Increase in the negative voltage results in considerable extension of the mode-locking regime and also to additional pulse shortening. The highest peak power for this laser structure operating at 30° C. is achieved at the forward current of 220 mA which results in an average power of 25.5 mW. The corresponding autocorrelation trace exhibits a full width at half maximum (FHWM) of 7.2 ps corresponding to a mode-locked pulse width, τ, of 5.1 ps, assuming a Gaussian pulse shape. The pulse energy and the peak power are estimated to be 5 pJ and 1 W, respectively. Even shorter (FWHM of 3.2 ps) pulses of higher peak power (1.7 W) are achieved at 60° C. The achieved peak power represents the highest level obtained directly from fully-monolithic mode-locked lasers, emphasizing the utility of the mode-locked lasers of the present invention for high-power mode-locked operation.

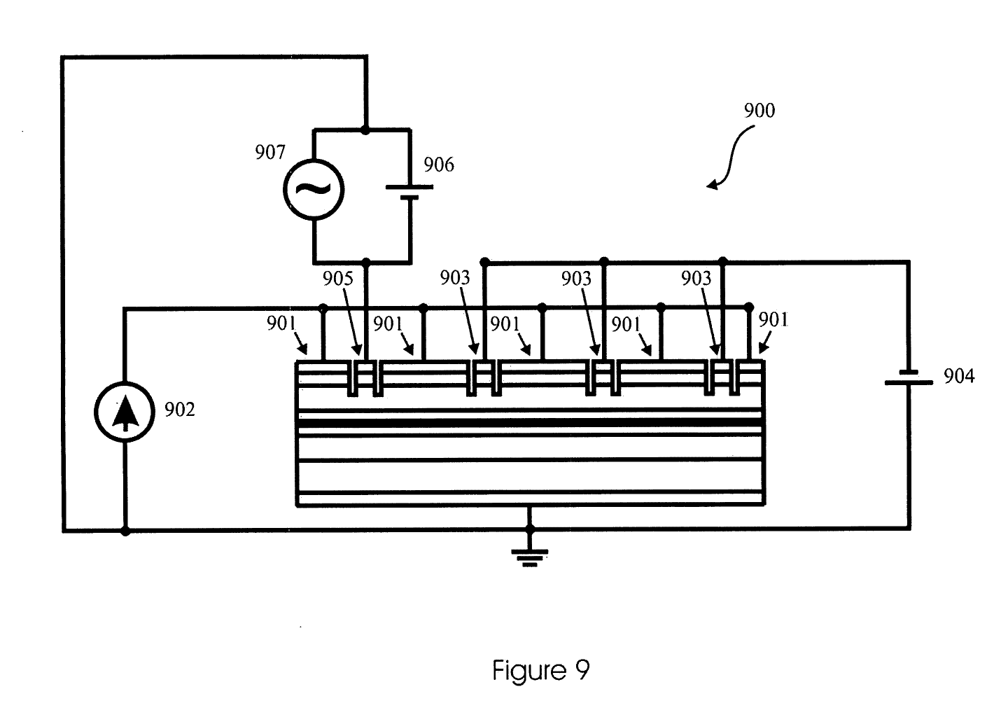

In another embodiment, a monolithic mode-locked diode laser is driven as a hybrid mode-locked laser (900) as illustrated in FIG. 9.

Subsections (901), which correspond to the longer subsections (609) of FIG. 6, are electrically connected in parallel. In normal use of this laser diode, a suitable forward current is provided by a DC source (902), which is applied to the subsections (901) to cause laser light generation. Subsections (903), which correspond to shorter subsections (610) of FIG. 6, are electrically connected in parallel. In normal use of this laser diode, a suitable negative bias is provided by a DC source (904) which is applied to the subsections (903) to cause the absorption of low intensity pulses and propagation of high intensity pulses.

Section (905), which corresponds to one of the shorter subsections (610) of FIG. 6, is driven by both a negative bias from a DC source (906) and a radio-frequency signal from a RF source (907) coupled through a bias-tee. Other elements, such as inductors and capacitors, may be included for the sake of impedance matching. During normal use, the frequency of the RF signal coincides with the fundamental repetition frequency of the optical pulse sequence in order to stabilize the fundamental mode-locking regime and reduce jitter.

Thus, typically subsections (901) act as gain subsections and the plurality of gain subsections (901) operate as a multiple gain section of the mode-locked laser diode (900). The subsections (903) act as saturable absorber subsections and the plurality of gain subsections (903) operate as a multiple gain section of the mode-locked laser diode (900); the section (905) operates as a modulator section. The mode-locked laser (900), as a whole, operates as a hybrid mode-locked laser.

Due to the multiple nature of the gain and saturable absorber sections, the light distribution along the cavity of the mode-locked laser is essentially uniform. The characteristic spike of the photon density (which may be formed at the boundary of modulator and gain sections of a conventional three-section laser) exists in the invented hybrid mode-locked laser, albeit to a lesser extent. This embodiment has all the advantages of the previously described passive mode-locked laser with an additional advantage of lower jitter.

In yet another embodiment, in addition to the multiple gain section and multiple saturable absorber section described in the embodiments of FIGS. 7 and 9, the invented monolithic mode-locked laser may include other elements to provide additional functionality to the device. For example, the mode-locked laser may optionally include a passive subsection allocated between the neighboring gain and absorber subsections. These passive subsections may have the variable refractive index and therefore can be used in order to stabilize the effective length of the laser cavity.

It is important to note that the passive subsections are intended for purposes other than decreasing the repetition frequency and therefore are quite short with respect to the total cavity length. This feature is an important distinction between the laser of the present invention and the extended-cavity mode-locked lasers of the prior art, which include lengthy passive section(s).

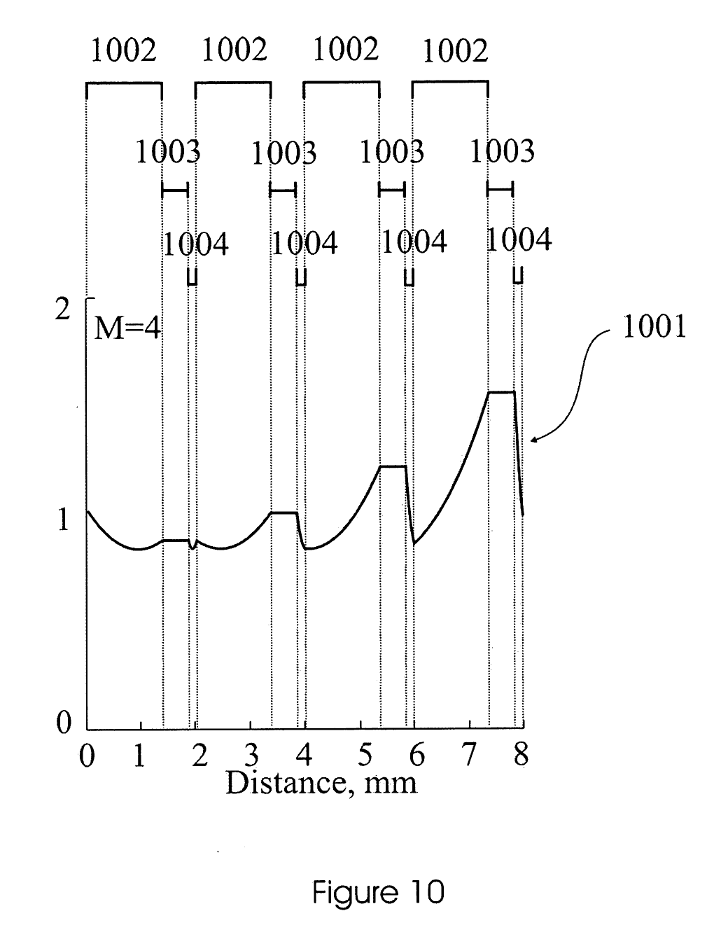

Because these passive subsections are nearly transparent for the light propagating inside the cavity, the light does not change its intensity during propagation along these subsections. Consequently, these subsections do not affect the amplitude of the light's nonuniformity. FIG. 10 illustrates the photon density distribution (1001) along the 8-mm-long cavity in mode-locked lasers including a fourfold sequence (M=4) of gain subsections (1002), passive subsections (1003), and saturable absorber subsections (1004).

In this example, the lengths of gain, passive, and saturable absorber subsections are L_{GM}=1.44, L_{PM}=0.4, and L_{AM}=0.16 mm, respectively. The absorption coefficient α in the saturable absorber subsections is assumed to be 30 cm⁻¹. Under the aforementioned conditions, the optical gain G in the gain subsections that corresponds to the laser threshold is 5.4 cm⁻¹. Accordingly, the reciprocal optical gain coefficient, 1/G, is 1.85 mm and the reciprocal absorption coefficient, 1/α, is 0.33 mm. Consequently, the design criteria (L_{GM}<1/G; L_{AM}<1/α) stipulated in the description of the mode-locked laser of the present invention are met. It can be clearly seen in FIG. 10 that the photon density distribution (1001) is very uniform. The ratio of the maximum to the minimum photon densities does not exceed 1.8, which is comparable with that of a single-section Fabry-Perot laser as shown by the curve (100) in FIG. 1.

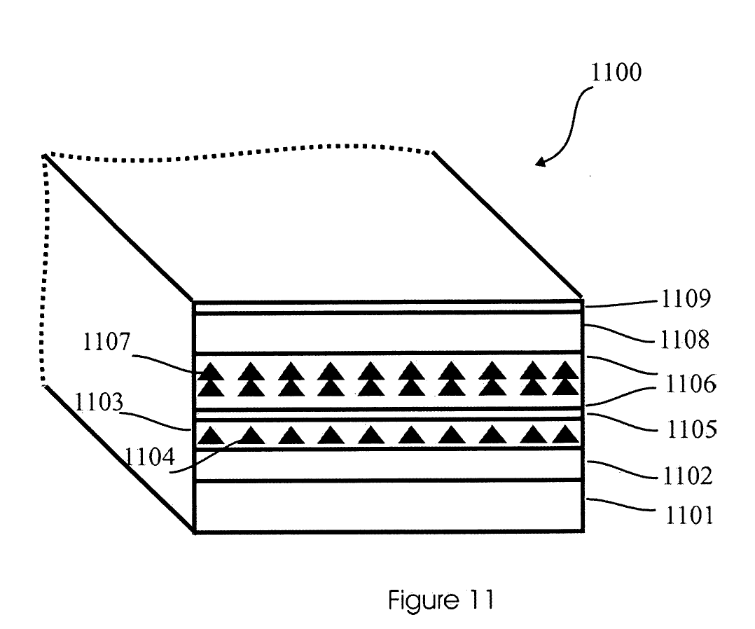

Still yet another embodiment is presented in FIG. 11, in which a layered sequence of an epitaxial structure (1100) of a monolithic passively mode-locked diode laser includes a distributed gain element (1107) and a distributed saturable absorber element (1104). The distributed gain element (1107) and the distributed saturable absorber elements (1104) are preferably quantum dot regions in this embodiment.

On an n+ doped GaAs substrate (1101), an n-AlGaAs first cladding layer (1102) is grown followed by an n-GaAs first matrix layer (1103), in which a first quantum dot region (1104) is contained. Then, the rest of the first n-AlGaAs cladding layer (1105) is deposited followed by a second GaAs matrix layer (1106) containing a second quantum dot region (1107) followed by a p-AlGaAs second cladding layer (1108), and a p+ GaAs contact layer (1109).

Each quantum dot region (1104) or (1107) may contain one or several planes of Stranski-Krastanow self-organized quantum dots embodied in an InGaAs material system. All the planes of quantum dots are preferably deposited under the same growth conditions, such that all planes are equivalent to each other in terms of their spectral characteristics.

The epitaxial structure (1100) is deposited by molecular beam epitaxy and then processed by known methods into a ridge-waveguide Fabry-Perot diode laser. During normal use, a forward bias is applied to the structure. Due to their low effective mass, electrons can freely flow from the first cladding layer (1102) to the rest of the first cladding layer (1105) through the first matrix layer (1103) and the first quantum dot region (1004). Therefore, electrons are injected into the second matrix layer (1106). Holes are injected into the second matrix layer (1106) from the second cladding layer (1008). Injected electrons and holes are then captured into quantum dots of the second quantum dot region (1107) producing optical gain. Therefore, the second quantum dot region (1107) acts as the distributed gain element in accordance with FIGS. 4 and 5.

At the same time, holes injected into the second matrix layer (1106) can not freely flow to the first matrix layer (1103) through the rest of the first cladding layer (1165). As a result, the quantum dots of the first quantum dot region (1104) only contain electrons and, therefore, provide optical absorption. Therefore, the first quantum dot region (1104) acts as the distributed saturable absorber element in accordance with FIGS. 4 and 5.

The second matrix layer (1106) preferably acts as a transverse optical waveguide which is confined by the cladding layer (1108) from one side and by the cladding layers (1102) and (1105) from the other side. A preferred width for the second matrix layer (1106) is about 0.4 μm. The first matrix layer (1103) is much narrower (preferably about 20 nm). Therefore its presence does not disturb significantly light distribution in a transverse optical mode. The first matrix layer ensures quantum barriers for the first quantum dot region (1104), which are similar to those of the second quantum dot region (1107).

The first matrix layer (1103) and the first quantum dot region (1104) are both preferably deposited at a low temperature. In one embodiment, they are deposited at temperatures below 350° C. For example, the first matrix layer (1103) and the first quantum dot region (1104) are deposited at a temperature around 300° C., in order to create a sufficient concentration of non-radiative recombination centers.

The first quantum dot region (1104) preferably contains one plane of quantum dots, while the second quantum dot region (1107) preferably contains from 5 to 10 planes of quantum dots separated by 30-nm thick GaAs spacer layers. The thickness of the rest (1105) of the first cladding layer is preferably about 50 nm. These features provide the appropriate relative coefficient of optical absorption in the distributed saturable absorber element with respect to optical gain in the distributed gain element.

It should be understood by those skilled in the art that various modifications follow the spirit and scope of the present invention provided that light distribution is essentially uniform owing to the multiple nature of the gain and saturable absorber sections.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A monolithic mode-locked diode laser comprising:
a) a multiple gain section comprising a plurality of gain subsections wherein a length of each gain subsection is less than a reciprocal gain coefficient in the gain subsection; and
b) a multiple saturable absorber section comprising a plurality of saturable absorber subsections wherein a length of each saturable absorber subsection is less than a reciprocal absorption coefficient in the saturable absorber subsection;
wherein the gain subsections alternate with the saturable absorber subsections;
wherein the gain subsections and the saturable absorber subsections are optically coupled in a single waveguide; and
wherein the gain subsections and the saturable absorber subsections are allocated inside a monolithic cavity such that a total length of the multiple gain section and the multiple saturable absorber section are substantially equal to a length of the monolithic cavity.

2. The mode-locked laser of claim 1 further comprising at least one passive subsection allocated between neighboring gain subsections and saturable absorber subsections; wherein the passive subsection is nearly transparent for light pulses circulating inside the cavity.

3. The mode-locked laser of claim 1, wherein the the saturable absorber subsections are located such that at least one of the following conditions is not satisfied:
a) coordinates of centers of all of the saturable absorber subsections correspond to K/N fractions of the cavity length, where K and N are integers without a common divisor;
b) N is common for all of the saturable absorber subsections; and
c) N is less than a reciprocal product of a fundamental optical frequency and an absorber recovery time;
such that the laser performs mode-locking at the fundamental optical frequency.

4. The mode-locked laser of claim 1 wherein:
all of the gain subsections are electrically connected in parallel and forward biased; and
all of the saturable absorber subsections are electrically connected in parallel and negatively biased;
such that the laser operates as a passively mode-locked laser.

5. The mode-locked laser of claim 1 wherein:
all of the gain subsections are electrically connected in parallel and forward biased;
all of the saturable absorber subsections except for one saturable absorber subsection are electrically connected in parallel and negatively biased;
one saturable absorber subsection is driven by both a negative bias and a radio-frequency with a frequency coinciding with a fundamental repetition frequency of an optical pulse sequence;
such that the laser operates as a hybrid mode-locked laser.

6. The mode-locked laser of claim 1 wherein all of the saturable absorber subsections are of equal length.

7. The mode-locked laser of claim 1 wherein the length of the monolithic cavity is adjusted such that a fundamental optical frequency is in a range of 5 to 20 GHz.

8. The mode-locked laser of claim 1 comprising greater than three gain subsections and greater than three saturable absorber subsections.

9. The mode-locked laser of claim 1, wherein the saturable absorber subsections are asymmetrically located with respect to a center of the monolithic cavity.

10. The mode-locked laser of claim 1, wherein the saturable absorber subsections are aperiodically located with respect to a center of the monolithic cavity.

11. A monolithic mode-locked laser comprising:
a) a distributed gain element; and
b) a distributed saturable absorber element optically coupled to the distributed gain element in a laser optical waveguide;
wherein the distributed gain element and the distributed saturable absorber element are allocated along a whole length of a laser cavity;
wherein the distributed gain element is placed such that both electrons and holes are injected into the distributed gain element to produce optical gain under an appropriate forward bias; and
wherein the distributed saturable absorber element is placed such that only one type of charge carrier selected from the group consisting of electrons and holes are injected into the saturable absorber element.

12. The mode-locked laser of claim 11 wherein the cavity length is adjusted such that a fundamental optical frequency is in a range of 5 to 20 GHz.

13. The mode-locked laser of claim 11 wherein the distributed gain element and the distributed saturable absorber element are formed by at least one plane of self-organized quantum dots.

14. The mode-locked laser of claim 13 wherein the quantum dots of the distributed saturable absorber element are deposited at temperatures below 350° C.

15. The mode-locked laser of claim 11 wherein the distributed gain element and the distributed saturable absorber element are formed by at least one quantum well.

16. The mode-locked laser of claim 11, wherein the distributed gain element and the distributed saturable absorber element are identical with respect to a plurality of spectral characteristics.

17. The mode-locked laser of claim 11, wherein:
a) the distributed gain section comprises a plurality of gain subsections wherein a length of each gain subsection is less than a reciprocal gain coefficient in the distributed gain element; and
b) the distributed saturable absorber element comprises a plurality of saturable absorber subsections wherein a length of each saturable absorber subsection is less than a reciprocal absorption coefficient in the distributed saturable absorber element.

18. A method of providing uniform light distribution along a cavity of a mode-locked laser comprising the step of designing the mode-locked diode laser to include:
a) a multiple gain section comprising a plurality of gain subsections wherein a length of each gain subsection is less than a reciprocal gain coefficient in the gain subsection; and
b) a multiple saturable absorber section comprising a plurality of saturable absorber subsections wherein a length of each saturable absorber subsection is less than a reciprocal absorption coefficient in the saturable absorber subsection;
wherein the gain subsections alternate with the saturable absorber subsections;
wherein the gain subsections and the saturable absorber subsections are optically coupled in a single waveguide;
wherein the gain subsections and the saturable absorber subsections are allocated inside a monolithic cavity such that a total length of the multiple gain section and the multiple saturable absorber section are substantially equal to a length of the monolithic cavity.

19. The method of claim 18, wherein the saturable absorber subsections are located such that at least one of the following conditions is not satisfied:
i) coordinates of centers of all of the saturable absorber subsections correspond to K/N fractions of the cavity length, where K and N are integers without a common divisor;
ii) N is common for all of the saturable absorber subsections; and
iii) N is less than a reciprocal product of a fundamental optical frequency and an absorber recovery time;
such that the laser performs mode-locking at the fundamental optical frequency.
